(19) United States
(12) Patent Application Publication
(10) Pub. No.: US 2023/0366050 A1
(43) Pub. Date: Nov. 16, 2023

(54) Device to inject a reducing gas into a shaft furnace

(71) Applicant: ArcelorMittal, Luxembourg (LU)

(72) Inventors: Edouard IZARD, Saint Julien Les Metz (FR); Dominique SERT, Montoy Flanville (FR); Jérôme DAULMERIE, Dunkerque (FR)

(21) Appl. No.: 18/025,987

(22) PCT Filed: Sep. 15, 2020
(86) PCT No.: PCT/IB2020/058563

§ 371 Date: Mar. 13, 2023

(51) Int. Cl. C21B 7/16; F27D 3/16; C21B 5/00

(52) U.S. Cl. CPC C21B 7/163; F27D 3/16; C21B 5/001; F27D 2003/166

(57) ABSTRACT

A device to inject a reducing gas into a shaft furnace including an external casing whose front face is provided with an outlet for gas injection into the shaft furnace, an internal casing located inside the external casing and made of a steel able to resist to a temperature up to 1200° C., this internal casing having an opening matching the gas injection outlet of the front face of the external casing and a refractory layer located between the external casing and the internal casing.

The invention is related to a device for injection of a reducing gas into a shaft furnace.

### BACKGROUND

In blast furnaces, the conversion of the iron-containing charge (sinter, pellets and iron ore) to cast iron, or hot metal, is conventionally carried out by reduction of the iron oxides by a reducing gas (in particular containing CO, H2 and N2), which is formed by combustion of coke at the tuyeres located in the bottom part of the blast furnace where air preheated to a temperature between 1000° C. and 1300° C., called hot blast, is injected.

In order to increase the productivity and reduce the costs, auxiliary fuels are also injected at the tuyeres, such as coal in pulverized form, fuel oil, natural gas or other fuels, combined with oxygen enrichment of the hot blast.

The gas recovered in the upper part of the blast furnace, called top gas, mainly consists of CO, CO2, H2 and N2 in respective proportions of 20-28% v, 17-25% v, 1-5% v and 48-55% v. Despite partial use of this gas as fuel in other plants, such as power plants, blast furnace remains a significant producer of CO2.

### SUMMARY OF THE INVENTION

In view of the considerable increase in the concentration of CO2 in the atmosphere since the beginning of the last century and the subsequent greenhouse effect, it is essential to reduce emissions of CO2 where it is produced in a large quantity, and therefore in particular at blast furnaces.

For this purpose, during the last 50 years, the consumption of reducing agents in the blast furnace has been reduced by half so that, at present, in blast furnaces of conventional configuration, the consumption of carbon has reached a low limit linked to the laws of thermodynamics.

One known way of additionally reducing CO2 emissions is to reintroduce top gases that are purified of CO2 and that are rich in CO into the blast furnace, said blast furnaces are known as TGRBF (Top-Gas Recycling Blast Furnaces). The use of CO-rich gas as a reducing agent thus makes it possible to reduce the coke consumption and therefore the CO2 emissions. This injection may be done at two levels, at the classical tuyere level, in replacement of hot blast and in the reduction zone of the blast furnace, for example in the lower part of the stack ok the blast furnace.

Injection at the tuyere level may be performed at the location of the existing equipment. However, in current practice there is no injection at the reduction zone level and new equipment must thus be installed. Classical hot blast tuyere are complex and heavy equipment which cannot be easily installed as such at this level.

There is so a need for a device allowing injection of reducing gas which is simple and easy to implement.

The present invention provides a device comprising an external casing having a rear and a front face which is provided with an outlet for gas injection into the shaft furnace, an internal casing located inside the external casing and made of a steel able to resist to a temperature up to 1200° C., this internal casing having an opening matching the gas injection outlet of the front face of the external casing.

The device of the invention may also comprise the following optional characteristics considered separately or according to all possible technical combinations:
a refractory layer is located between the external and the internal casings,
the internal steel casing is made of stainless steel,
the device does not comprise any cooling system.
the shaft furnace is a blast furnace,
the device is bolted to the shaft furnace,
the device further comprises reinforcing plates to support the internal casing,
the internal casing is designed so that injection of the reducing gas inside the shaft furnace is performed downwards,
the internal casing is designed so that injection of the reducing gas inside the shaft furnace is performed at an angle α with the perpendicular to the shaft furnace internal wall comprised between 0 and 30°,
the device comprises a stone box in the upper part of the front face,
the front face of the external casing has a triangular shape.
the front face of the external casing is composed of an upper part and of a lower part, the lower part is in recess from the upper part and the gas injection outlet is provided in the lower part of the front face.
the front face of the external casing is composed of an upper part and of a lower part, the lower part being inwardly chamfered from the upper par and the gas injection outlet being provided in the lower part of the front face.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a side view of a blast furnace equipped with reducing gas injection devices

FIG. 2 illustrates a top view of a blast furnace with reducing gas injection

FIG. 3 illustrates an injection device according to a first embodiment of the invention

FIG. 4 illustrates an injection device according to a second embodiment of the invention

FIG. 5 illustrates an injection device according to a third embodiment of the invention

FIG. 6 illustrates an injection device according to a fourth embodiment of the invention

### DETAILED DESCRIPTION

Elements in the figures are for illustration only and may not have been drawn to scale. Same references are used for same elements from one figure to another.

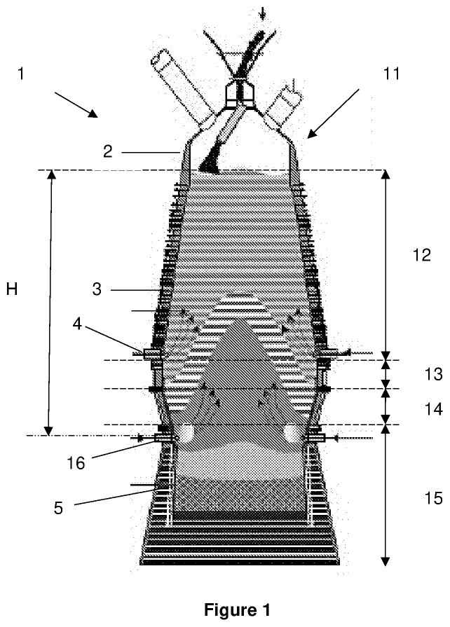

FIG. 1 is a side view of a blast furnace according to the invention. The blast furnace 1, comprises, starting from the top, a throat 11 wherein materials are loaded and gas exhaust, a stack (also called shaft) 12, a belly 13, a bosh 14 and a hearth 15. The materials loaded are mainly iron-bearing materials such as sinter, pellets or iron ore and carbon-bearing materials such as coke. The hot blast injection necessary to carbon combustion and thus iron reduction is performed by tuyeres 16 located between the bosh 14 and the hearth 15. In terms of structure, the blast furnace has an external wall, or shell 2, this shell 2 being covered, on the inside of the blast furnace, by a refractory lining and staves 3, as illustrated in FIG. 3, forming an internal wall 5. To reduce consumption of coke, which is the main carbon provider for iron reduction, it has been envisaged to inject a reducing gas in the blast furnace in addition to the hot blast. This reducing gas injection is performed in the stack of the blast furnace, preferentially in the lower part of the stack 12, for example just above the belly 13.

In a preferred embodiment the reducing gas injection is performed at a distance from the classical tuyere level, comprised between 20% and 70%, preferentially between 30 and 60% of the working height H of the furnace. The working height H of a blast furnace is the distance between the level of injection of hot blast through classical tuyeres and the zero level of charging, as illustrated in FIG. 1.

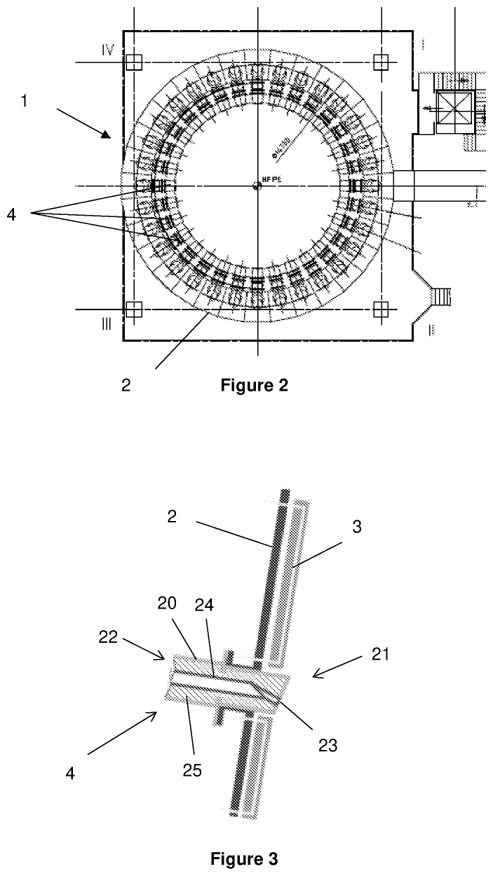

The injection is performed through several injection outlets 4 around the circumference of the furnace, as illustrated in FIG. 2, which is a top view of the blast furnace 1 at the level of injection of the reducing gas. In a preferred embodiment there are as many injection outlets as staves forming the internal wall 2. Between 200 and 700 Nm³ of reducing gas is injected per ton of hot metal in the blast furnace.

FIGS. 3 to 6 illustrate an injection device 4 according to different embodiments of the invention. In all embodiments the injection device 4 comprises an external casing 20 having a front face 21 and a rear face 22. The front face 21 is the face located inside the furnace and is provided with an outlet 23 for injecting the reducing gas into the furnace. The injection device 4 further comprises an internal casing 24 located inside the external casing 20 and made of a steel able to resist to a temperature up to 1200° C., preferably of stainless steel. This internal casing 24 has an opening matching the gas injection outlet 23 of the front face 21 of the external casing 20. A refractory layer 25 may furthermore be provided between the external 20 and the internal casing 24. The internal casing 24 is able to transport the reducing gas, having a temperature comprised between 800° C. and 1200° C., up to the gas injection outlet 23 so that said reducing gas is injected into the blast furnace 1. The internal casing 24 and the gas injection outlet 23 are designed so that the injection of the reducing gas inside the blast furnace stack is performed downwards and preferably at an angle α with the perpendicular to the internal wall comprised between 0 and 30°. The diameter of the internal casing 24 is chosen to fulfil required speed injection in the blast furnace. In a preferred embodiment this speed is comprised between 75 and 200 m/s. In another embodiment it is inferior to 60 m/s. The refractory layer 25 allows to mitigate the variation of temperature of the reducing gas circulating into the internal casing 24.

Compared to classical tuyeres, the injection device 4 according to the invention preferentially does not comprise any cooling means, which make it lighter and easier to conceive.

The front face 21 may have a circular or a triangular shape. The triangular shape has the advantage of decreasing the mechanical load on the front face 21 and making smoother the granular materials flow on the front face 21 in comparison with a traditional circular shape.

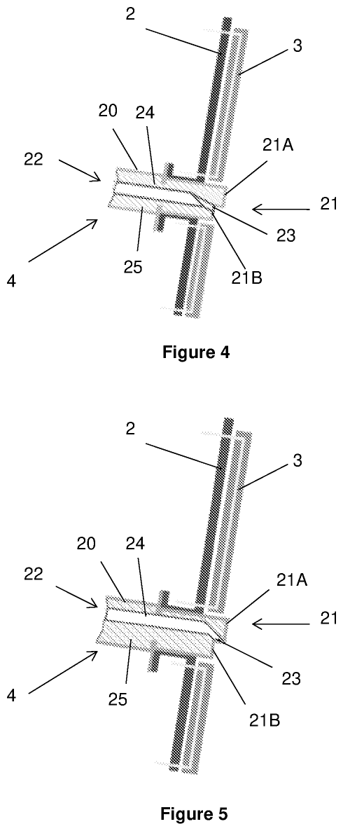

In the embodiment of FIG. 4, the front face 21 of the injection device 4 comprises two parts, an upper part 21A and a lower part 21B. The lower part 21B is in recess from the upper part 21A and the gas injection outlet 23 is located in the recessed lower part 21B. This allows creation of a cavity without material around the gas injection outlet 23 and thus to avoid it becoming dirty and/or being clogged. This improves the lifetime of the injection device 4.

In the embodiment of FIG. 5, the external casing 20 has the same design as the embodiment of FIG. 4 but the injection outlet 23 is located at a different location of the lower part 21B.

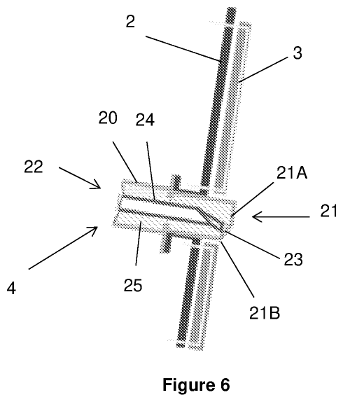

In the embodiment of FIG. 6, the front face 4 comprises also two parts, an upper part 21A and a lower part 21B. In this embodiment, the lower part 21B is chamfered from the upper part 21A and the gas injection outlet 23 is located in the recessed lower part 21B. As in the previous embodiment this allows to create a cavity without material around the gas injection outlet 23 and thus to avoid it becoming dirty and/or being clogged. This improves the lifetime of the injection device 4.

An injection device 4 according to the invention may further be provided on its front face with a stone box which aims to locally reinforce the external casing 20 and protect it from abrasion by the burden falling into the furnace and thus to improve the lifetime of the injection device 4. This feature may be combined with anyone of the previously described embodiment.

The injection device according to any one of the previous embodiments is attached to the shell of the blast furnace 1. It may be bolted or welded to this shell.

The injection device according to any of the previous embodiments may be preferentially used for injection of a reducing gas at shaft level in a blast furnace and more specifically in a Top Gas Recycling Blast furnace. This reducing gas contains preferentially between 65% v and 75% v of carbon monoxide CO, between 8% v and 15% v of hydrogen H2, between 1% v and 5% v of carbon dioxide CO2, remainder being mainly nitrogen N2. It is preferentially injected at a temperature comprised between 850 and 1200° C.

What is claimed is:

1-13. (canceled)

14. A device to inject a reducing gas into a shaft furnace, the device comprising:
an external casing having a rear and a front face, the front face being provided with an outlet for gas injection into the shaft furnace; and
an internal casing located inside the external casing and made of a steel able to resist to a temperature up to 1200° C., the internal casing having an opening matching the gas injection outlet of the front face of the external casing.

15. The device as recited in claim 14 further comprising a refractory layer 25 located between the external casing and the internal casing.

16. The device as recited in claim 14 wherein the internal steel casing is made of stainless steel.

17. The device as recited in claim 14 wherein no cooling system is present.

18. The device as recited in claim 14 wherein the shaft furnace is a blast furnace.

19. The device as recited in claim 14 wherein the device is bolted to the shaft furnace.

20. The device as recited in claim 14 further comprising reinforcing plates to support the internal casing.

21. The device as recited in claim 14 wherein the internal casing is designed so that injection of the reducing gas inside the shaft furnace is performed downwards.

22. The device as recited in claim 21 wherein the internal casing is designed so that injection of the reducing gas inside the shaft furnace is performed at an angle □□ with the perpendicular to the shaft furnace internal wall comprised between 0 and 30°.

23. The device as recited in claim 14 further comprising a stone box in the upper part of the front face.

24. The device as recited in claim 14 wherein the front face of the external casing has a triangular shape.

25. The device as recited in claim 14 wherein the front face of the external casing is composed of an upper part and of a lower part, the lower part being recessed from the upper part and the gas injection outlet being provided in the lower part of the front face.

26. The device as recited in claim 14 wherein the front face of the external casing is composed of an upper part and of a lower part, the lower part being inwardly chamfered from the upper part and the gas injection outlet being provided in the lower part of the front face.
